(19) United States
(12) Patent Application Publication
(10) Pub. No.: US 2018/0226636 A1
(43) Pub. Date: Aug. 9, 2018

(54) BATTERY POSITIVE ELECTRODE ACTIVE MATERIAL, BATTERY, AND METHOD FOR PRODUCING BATTERY POSITIVE ELECTRODE ACTIVE MATERIAL

(71) Applicants: NIPPON KODOSHI CORPORATION, Kochi-shi (JP); TOYOTA JIDOSHA KABUSHIKI KAISHA, Toyota-shi (JP)

(72) Inventors: Haruo SAWA, Kochi-shi (JP); Haruyuki NAKANISHI, Toyota-shi (JP)

(73) Assignees: NIPPON KODOSHI CORPORATION, Kochi-shi (JP); TOYOTA JIDOSHA KABUSHIKI KAISHA, Toyota-shi (JP)

(21) Appl. No.: 15/747,528

(22) PCT Filed: Jun. 29, 2016
(86) PCT No.: PCT/JP2016/069328

§ 371 Date: Jan. 25, 2018

(30) Foreign Application Priority Data
Jul. 29, 2015 (JP) 2015-149907

(51) Int. Cl. H01M 4/32; H01M 10/34; C01G 53/04; C01B 6/02

(52) U.S. Cl. CPC H01M 4/32; H01M 10/345; C01G 53/04; H01M 2004/028; H01M 2220/20; C01P 2006/40; C01P 2002/72; C01B 6/02

(57) ABSTRACT

This battery positive electrode active material contains at least one compound selected from nickel hydroxide, nickel oxyhydroxide and derivatives of these which cause a redox reaction during battery operation, or alternatively contains a metal oxide, or derivative thereof, which does not cause a redox reaction during battery operation, or an inorganic-organic hybrid compound formed by an organic polymer having a hydroxyl group chemically bonding with said metal oxide or derivative. In a diffraction intensity-angle diagram obtained by powder X-ray diffraction using CuKα radiation in a state in which the active material contains nickel hydroxide, the half-value width of the diffraction peak corresponding to the crystal 001 plane of the nickel hydroxide is greater than or equal to 2 (2θ°) and preferably greater than or equal to 4 (2θ°), or there is no diffraction peak.

### TECHNICAL FIELD

The present invention relates to a battery positive electrode active material, a battery including a positive electrode which contains a battery positive electrode active material, and a method for producing a battery positive electrode active material.

### BACKGROUND ART

In general, a battery is formed from two electrodes, that is, a positive electrode and a negative electrode, a separator separating the electrodes from each other, and an electrolyte liquid which pervades the entire battery. A negative electrode active material has a property of being likely to transfer electrons to a positive electrode active material, and during discharge, since electrons are transferred from the negative electrode active material to the positive electrode active material through an external circuit, an electric current flows. That is, during discharge, the negative electrode active material is oxidized, and the positive electrode active material is reduced. However, if only the transfer of electrons between the positive electrode and the negative electrode through the external circuit occurs, the same kind of charge is continuously accumulated at the positive electrode and the negative electrode, respectively, and immediately, electric current stops flowing. Hence, the liquid electrolyte allows ions to transfer between the positive electrode and the negative electrode so as to release the accumulated charges, and as a result, a constant electric current is obtained. The separator is provided so as to prevent a so-called short circuit by which an electric current cannot be extracted outside because of direct electron transfer between the positive electrode active material and the negative electrode active material caused by contact therebetween. When a secondary battery is charged, the voltage is applied thereto from the outside so as to perform electron transfer in a direction opposite to the abovementioned. That is, during charge, the negative electrode active material is reduced, and the positive electrode active material is oxidized.

In recent years, for example, because of the spread of mobile devices, the spread of hybrid cars due to environmental and energy issues, or the development of electric cars and stationary type large batteries for surplus electric power storage, roles to be performed by batteries, in particular, by secondary batteries, and the expectations therefor have been further increased. In particular, a significant improvement in fuel efficiency by hybrid cars achieves not only cost reduction of users but also a great effect on the environmental and energy issues, such as emission reduction of CO₂ and saving of oil resources. Hereinafter, when the battery is further improved, and when the electric cars are further spread, fundamental emission reduction of CO₂ and energy shift which is not dependent on fossil fuels can be realized, and a further significant effect on the environmental and energy issues can be expected. In those car-related fields, the energy consumption scale is originally large, and the influence on the environment and energy is also large. In addition to basic properties, such as an energy density, a large current charge/discharge performance, and durability, an in-car battery is required to satisfy, severe performance conditions, such as easy control, and is desired to be further improved.

Since a nickel hydride battery which is one representative secondary battery uses a noncombustible aqueous liquid electrolyte, and since hydrogen itself used as a negative electrode active material is not a metal, short circuit is not likely to occur, and even if a relatively rapid charge is performed at a constant electric current, when the battery is fully charged, electrolysis of water in the liquid electrolyte is automatically performed instead so as to suppress an increase in voltage; hence, the nickel hydride battery is a relatively safe battery, and the charge thereof can also be easily controlled. Nowadays, many nickel hydride batteries have been used as batteries for hybrid cars. The nickel hydride battery uses a hydrogen occluding alloy as the negative electrode, nickel hydroxide as the positive electrode, and an alkaline liquid electrolyte as the liquid electrolyte, and on the negative electrode, as shown by the following formulas (1) and (2), during charge, electrochemical reduction of water molecules to hydrogen and occlusion of hydrogen into the hydrogen occluding alloy occur, and on the other hand, during discharge, electrochemical oxidation of occluded hydrogen occurs.

[Charge] H₂O+e⁻→H (occluded)+OH⁻ (1)

[Discharge] H (occluded)+OH⁻→H₂O+e⁻ (2)

As the hydrogen occluding alloy, an alloy primarily containing a rare earth and nickel has been mainly used.

On the positive electrode, as shown by the following formulas (3) and (4), an electrochemical redox reaction of nickel hydroxide or nickel oxyhydroxide occurs.

[Charge] Ni(OH)₂+OH⁻→NiOOH+H₂O+e⁻ (3)

[Discharge] NiOOH+H₂O+e⁻→Ni(OH)₂+OH⁻ (4)

As a battery using a positive electrode (nickel electrode) which uses nickel hydroxide or nickel oxyhydroxide as described above, besides the nickel hydride battery, for example, a nickel iron battery and a nickel zinc battery may be mentioned. The former is a battery in which the negative electrode of the nickel hydride battery is replaced with an iron electrode (see the following formulas (5) and (6)).

[Charge] Fe(OH₂)+2e⁻→Fe+2OH⁻ (5)

[Discharge] Fe+2OH⁻→Fe(OH)₂+2e⁻ (6)

The latter is a battery using a zinc electrode instead (see the following formulas (7) and (8)).

[Charge] ZnO+H₂O+2e⁻→Zn+2OH⁻ (7)

[Discharge] Zn+2OH⁻→ZnO+H₂O+2e⁻ (8)

When the iron electrode is used, although a potential similar to that of a hydrogen occluding alloy electrode which is the negative electrode of the nickel hydride battery is obtained, and in addition, a larger theoretical capacity can also be obtained, in practice, since passivated, the iron electrode is not active for a charge/discharge reaction, and under the present circumstances, this battery is hardly practically used. When the zinc electrode is used, although a battery having a higher energy density can be formed, zinc oxide is liable to be dissolved in an alkaline electrolyte liquid, and when eluted zinc ions are reduced during charge, needle-shaped metal zinc (dendrite) is generated and penetrates a separator to cause problems, such as short circuit, so that this battery is also difficult to be put into practical use. Hence, among batteries in which a nickel electrode is used, and an aqueous electrolyte is used, at the moment, the nickel hydride battery has been most widely used.

Heretofore, in general, a spherical high-density nickel hydroxide has been used as a nickel electrode active material of a positive electrode. Since being formed so that primary particles are agglomerated at a high density to form spherical secondary particles, this spherical high-density nickel hydroxide can be filled at a high density as the active material of the electrode, and hence, the battery capacity can be increased. Spherical high-density particles are formed in such a way that when being synthesized, nickel hydroxide is aged, for example, in a solution containing a complex forming agent, such as ammonia, and having a slight solubility for nickel hydroxide. That is, even if nickel hydroxide has an indeterminate form at the beginning, jag portions thereof having a high solubility are preferentially dissolved during the aging, the jag gradually disappear, and nickel hydroxide thus dissolved is precipitated in voids of the particles. When those steps are repeatedly performed, the particles change to have a spherical high-density shape. In this ageing process, crystals (primary particles) in the particles are also grown.

Nickel hydroxide and nickel oxyhydroxide are each a layered compound, and in particular, a conventional spherical high-density nickel hydroxide formed through an aging process has an apparent layered crystal. A synthesized nickel hydroxide has a stable β-type nickel hydroxide structure, and the composition thereof is approximately represented by Ni(OH)₂. On the other hand, a nickel oxyhydroxide formed by charge (by oxidation) has a higher Ni valance and become NiOOH by losing a proton (hydrogen ion) as shown in the formula (3), moreover the interlayer distance is increased in order to reduce a highly densified electric field caused by an increase in valence of Ni, water molecules, potassium hydroxide, sodium hydroxide, lithium hydroxide, and the like of the liquid electrolyte are intercalated between the layers. In particular, on the Ni electrode in a highly charged state, the valence of Ni is remarkably increased, and the interlayer distance is widely increased thereby, so that a γ type structure in which many water molecules and the like are intercalated between the layers may be formed in some cases. The γ type nickel oxyhydroxide has a low charge/discharge potential, a function of decreasing a battery voltage, and a low activity for a charge/discharge reaction. In addition, when a large amount of the γ type nickel oxyhydroxide is generated, since a large amount of water of the liquid electrolyte is absorbed in and fixed to the nickel electrode, and the volume of the nickel electrode itself is also remarkably increased, in a closed type battery, dry up of the separator occurs, and the battery life is adversely influenced. As described above, since the formation of the γ type nickel oxyhydroxide has an unfavorable function on the battery, in order to suppress this formation, in a conventional nickel hydroxide, partial replacement (solid solution) of nickel with zinc has been frequently performed.

In addition, since nickel hydroxide itself has no electron conductivity, and in particular, at a discharge end period, since the progress of a charge/discharge reaction becomes very slow, in order to compensate for the electron conductivity, partial substitution (solid solution) of nickel with cobalt or coating of a cobalt oxide on surfaces of nickel hydroxide particles has been generally performed. In addition, to add a divalent cobalt compound, such as cobalt oxide, into a nickel electrode is also effective. When a liquid electrolyte is supplied in a battery, cobalt is dissolved, and is oxidized at subsequent charge not to be dissolved, so that the surface of nickel hydroxide is automatically placed in a state coated with cobalt.

As described above, although the nickel electrode has various basic problems, through the process carried out heretofore, considerable improvement has been made. However, one big problem which has not been overcome as of today is a so-called memory effect. Nowadays, in a nickel hydride battery used in a hybrid car and the like, when the battery is used by partial charge/discharge, that is, when the battery is used to be partially discharged and then partially charged so that the charged state thereof is not remarkably changed, an abnormal voltage behavior is shown, that is, the charge/discharge voltage thereof is different from that obtained when the battery is used so as to be fully discharged and then fully charged. Since the voltage behavior is changed dependent on how the battery is used, in general, this phenomenon is called a memory effect, and the battery control is made difficult; hence, the problem in that the original performance of the battery cannot be sufficiently obtained may arise in some cases. In the case of a mobile device and the like, when a user tries to perform deep charge/discharge, this problem may be prevented to a certain extent; however, when the battery is used in a hybrid car, since the partial charge/discharge is basically always performed in an intermediate charged state, the memory effect cannot be avoided from being generated.

This memory effect is caused by the nickel electrode and is deeply involved in the layered structure of nickel hydroxide or nickel oxyhydroxide. For example, Patent Literature 1 has disclosed that it is important that when a battery is left in a fully discharged state, the change in the c axis length (interlayer spacing) of nickel hydroxide hardly occurs, and that a method in which a solid solution amount of a divalent cation other than nickel is decreased by solid solution of trivalent or higher valent cations, such as tungsten, niobium, and zirconium, in nickel hydroxide is effective to suppress the memory effect.

Incidentally, although the following does not relate to the problem of the memory effect, the present inventors have disclosed that a material based on an inorganic-organic hybrid compound in which a zirconic acid compound and a polyvinyl alcohol are chemically bonded to each other can be used for an alkaline battery, such as a nickel hydride battery, and that since this material has a hydroxide ion conductivity in spite of being a solid, the material functions as an liquid electrolyte, and the other various functions can be imparted (see Patent Literatures 2, 3, and 4). For example, when those inorganic-organic hybrid compounds are used, the volume of the liquid electrolyte of the nickel hydride battery can be reduced and/or, by the short-circuit prevention function, the thickness of the separator can also be decreased. In addition, for example, an effect of suppressing dendrite generation of a zinc electrode in a nickel zinc battery has also been disclosed. Patent Literatures 2 and 3 have also disclosed that when a treatment of immersing those inorganic-organic hybrid compounds in an alkaline aqueous solution is performed, that is, when a treatment of absorbing an alkaline aqueous solution in those inorganic-organic hybrid compounds is performed, a high hydroxide ion conductivity can be obtained.

In addition, according to Patent Literatures 2 and 3, this inorganic-organic hybrid compound in which a zirconic acid compound and a polyvinyl alcohol are chemically bonded to each other can be obtained in such a way that a zirconium salt or an oxyzirconium salt is neutralized in a solution in which a polyvinyl alcohol coexists therewith, and a solvent is then removed. In addition, Patent Literatures 4 and 5 have disclosed a method in which a solid material in which a polyvinyl alcohol coexists with a zirconium salt or an oxyzirconium salt is formed in advance, and this solid material is brought into contact with an alkaline so as to neutralize the zirconium salt or the oxyzirconium salt.

### CITATION LIST

### Patent Literature

Patent Literature 1: Japanese Unexamined Patent Application Publication No. 2014-49210

Patent Literature 2: Japanese Patent No. 3848882

Patent Literature 3: Japanese Patent No. 4081343

Patent Literature 4: Japanese Patent No. 5095249

Patent Literature 5: Japanese Patent No. 4871225

### SUMMARY OF INVENTION

### Technical Problem

As is the case of the memory effect, when the curve of the battery voltage is changed depending on conditions under which the battery is used, the problem of battery control may arise. When a use voltage range of the battery is set, for example, even when being not sufficiently discharged, the battery is judged to be at a discharge limit, or even when being not sufficiently charged, the battery is judged to be in a charge complete state, so that the problem in that the original capacity cannot be sufficiently used may arise. In particular, in a hybrid car or the like, since the battery is used such that partial charge/discharge is always repeatedly performed in an intermediate charged state, the memory effect is liable to occur, and when the voltage is changed by the memory effect, the charged state is difficult to understand from the voltage, or an operation of returning the charged state to a reference state by controlling the voltage to a predetermined reference voltage is difficult to perform. Hence, in order to have a margin for use of the battery, for example, the use voltage range is narrowed in a safe range, so that the use condition under which the original battery performance cannot be obtained may be unfavorably selected.

As described above, the memory effect of the nickel hydride battery is caused by the layered structure of nickel hydroxide or nickel oxyhydroxide of the nickel electrode which is the positive electrode. In the nickel electrode, when nickel is in a divalent state or a state close thereto by being discharged, a β-Ni(OH)₂ phase in which the interlayer distance is decreased is thermodynamically stable. On the other hand, when nickel has a higher valence by being charged, in order to reduce a high electric field of nickel atoms, the interlayer distance is increased, so that a state in which water molecules having a high dielectric constant and the like are inserted between the layers is rather thermodynamically stable. Hence, although expansion and contraction of the interlayer distance and insertion and desorption of interlayer matters are basically to be progressively performed in association with charge and discharge, this process is very slow due to interlayer transfer of large water molecules and the like.

Hence, when the battery is used so that for example, deep charge/discharge is performed, and the charged state is largely changed in a relatively short time, the expansion and contraction of the interlayer distance and the insertion and desorption of the interlayer matters cannot completely follow the change, so that in an intermediate metastable state, the valence of nickel is only largely changed. A nickel electrode charge/discharge potential obtained when the deep charge/discharge as described above is performed is considerably different from the potential obtained when the expansion and contraction of the interlayer distance and the insertion and desorption of the interlayer materials are sufficiently performed. On the other hand, when partial charge/discharge is only performed, the change in charged state is small, and furthermore when a place at which a charge/discharge reaction is likely to occur and a place at which a charge/discharge reaction is not likely to occur are present in the electrode, the reaction is concentrated at the place at which the charge/discharge reaction is likely to occur, and at the place at which the reaction is not likely to occur, the charged state is further not changed. As described above, at a portion at which the reaction of the nickel electrode active material is not likely to occur, a time margin for transferring to a stable state by the expansion and contraction of the interlayer distance and the insertion and desorption of the interlayer matters can be obtained. In this case, the nickel electrode potential becomes different from that obtained when the deep charge/discharge is performed. As described above, since the nickel electrode potential is changed by how the charge/discharge is performed, the memory effect is generated.

When the memory effect is generated by the mechanism described above, it is believed that when the state in which trivalent or higher valent cations are introduced into nickel hydroxide, and the number of divalent cations is decreased so the interlayer distance is not decreased can be obtained as disclosed in Patent Literature 1, the memory effect may be probably suppressed.

However, in order not to decrease the interlayer distance, although a considerable amount of trivalent or higher valent cations is required to be solid-solved, since a conventional battery nickel hydroxide is processed by an aging step for forming spherical high-density particles, this nickel hydroxide is highly crystallized, and the purity thereof is rather improved, so that the solid-solution amount of foreign cations is limited.

On the other hand, even if a large amount of trivalent or higher valent cations can be solid-solved without passing through the aging step, those cations are components having no contribution to charge/discharge, and as a result, the capacity of the nickel electrode is seriously decreased.

In addition, a method for introducing high valent cations can suppress the decrease in interlayer distance at a low charged side but is difficult to prevent a large increase in interlayer distance at a high charged side.

Accordingly, by the method disclosed in Patent Literature 1, the memory effect cannot be sufficiently suppressed.

Incidentally, the presence of the slow steps, such as the expansion and contraction of the interlayer distance and the insertion and desorption of the interlayer matters, indicates that various material states (material species) are undesirably present in the electrode active material, and hence, the flatness of a charge/discharge voltage curve is degraded. That is, since a material which is likely to be discharged is discharged at a higher voltage, and a material which is not likely to be discharged is discharged at a lower voltage, as a result, the voltage is largely changed during discharge. In addition, since a material which is likely to be charged is charged at a lower voltage, and a material which is not likely to be charged is charged at a higher voltage, as a result, the voltage is largely changed during charge. When the flatness of the charge/discharge voltage curve is not good, for example, degradation in discharge characteristics at a discharge end period, a decrease in charge efficiency at a charge end period, and a decrease in storage energy use efficiency may occur.

In a conventional nickel electrode active material, the layered crystal is grown, and material states (material species) having different degrees of expansion between the layers are present, so that the flatness of the charge/discharge voltage curve is not good.

In a hybrid car and the like, although the battery is used so that partial charge/discharge is repeatedly performed, the charged state at the time can be basically obtained by integrating the balance of charge/discharge amount precisely. However, when the charge efficiency is not 100%, and/or self discharge occurs during the use, an actual charged state is shifted from that estimated from the charge/discharge integrated capacity. Accordingly, the charged state is gradually shifted as the battery is used, so that the voltage is changed. By this change described above, the battery is also difficult to control.

In this case, if the charge/discharge voltage curve is flat, the change in voltage caused by the shift of the charged state can be reduced. In addition, the change in voltage caused by the shift of the charged state can be recovered by controlling the voltage occasionally to the reference value so as to return the charged state to the reference state.

However, since the charge/discharge voltage curve of the conventional nickel electrode active material is not flat, the voltage is largely changed. In addition, in a battery using a conventional nickel electrode, since the memory effect is large, even when the voltage is controlled to the reference value, the charged state is not guaranteed to be returned to an intended reference state.

If nickel hydroxide or nickel oxyhydroxide has a more random structure having a very low crystallinity or an amorphous structure, the layered structure cannot be completely transferred to a stable state, so that the memory effect can be made not likely to appear. Furthermore, for example, when nickel hydroxide or nickel oxyhydroxide is fine particles, such as nanoparticles, since a stable layered structure cannot be formed, the memory effect can more basically be suppressed.

In addition, in fine particles, such as nanoparticles, since the layered structure itself cannot be formed, and the states of materials represented by the degree of expansion of the interlayer distance are not different from each other, very uniform charge/discharge is performed, and the charge/discharge potential curve is flattened.

That is, in view of the suppression of the memory effect, the flatness of the charge/discharge potential curve, and the like, a battery active material formed from nickel hydroxide, nickel oxyhydroxide, or at least one derivative thereof is ideally fine particles with low crystallinity, amorphous fine particles, or fine particles, such as nanoparticles. However, even when the battery active material as described above is produced, for example, by a general method in which nickel hydroxide is precipitated in a liquid phase using a nickel salt as a raw material, a sufficient material cannot be obtained. Furthermore, as described above, the conventional general battery nickel hydroxide is formed through the aging step so that the layered crystal is further grown, and is in a direction opposite to that of the ideal state. In order to obtain the effect for the suppression of the memory effect and the flatness of the charge/discharge potential curve, nickel hydroxide, nickel oxyhydroxide, or the derivative thereof is required to be sufficiently fine particles with low crystallinity, amorphous fine particles, or fine particles, such as nanoparticles, and this type of fine particles cannot be realized without performing a specific production method.

In addition, even if low crystallinity, amorphousness, or fine particles are formed to a certain extent, those materials are originally unstable and are being changed into a stabler crystal, and fine particles, such as nanoparticles, are agglomerated and are also further likely to be grown. For example, in order to prevent the agglomeration, the fine particles, such as nanoparticles, are stored in a liquid in many cases; however, when being formed into an electrode, the fine particles, such as nanoparticles, are eventually liable to be agglomerated. When a low crystalline or an amorphous electrode active material is repeatedly charged and discharged, that is, when a severe material change, such as an oxidation reaction and a reduction reaction, is repeatedly performed, the crystallization of the active material may be advanced in some cases.

As one method for stably maintaining fine particles with low crystallinity, amorphous fine particles, or fine particles, such as nanoparticles, generated fine particles are allowed to coexist with another stable material so as to prevent the agglomeration and/or the growth of the fine particles. Since the fine particles are allowed to coexist with another stable material, the fine particles are separated from each other, the agglomeration and/or the growth thereof can be prevented. Accordingly, the growth of the crystal can also be inhibited, so that a low crystallinity and an amorphous property can be maintained. However, the coexisting material is required to satisfy many conditions.

First, since functioning as an electrode active material, the coexisting material is required not to be a liquid but is required to be a solid. In addition, since the positive electrode of the battery is placed in a particularly strongly oxidative environment, the coexisting material is required to have a sufficient chemical stability against the environment. Furthermore, in order to enable the coexisting material to stably maintain a function of suppressing the agglomeration and the growth of the fine particles, in an electrode operation potential range, the coexisting material is preferably not to cause a redox reaction. In a battery, such as a nickel hydride battery, using an alkaline electrolyte, the coexisting material is required to have a resistance against a strong alkaline. Furthermore, in order to enable the electrode active material to have a sufficient function, the coexisting material itself more preferably has an ion conductivity. A solid material which satisfies the conditions described above, which can coexist with the fine particles, such as nanoparticles, and which has a property of preventing the agglomeration and the growth is desired.

### Solution to Problem

The present invention was made to overcome the related problems described above.

A battery positive electrode active material of the present invention is a battery positive electrode active material containing at least one compound selected from nickel hydroxide, nickel oxyhydroxide, and derivatives of these which cause a redox reaction during battery operation, and in a diffraction intensity-angle diagram obtained by a powder X-ray diffraction method using CuKα radiation in a state in which the active material contains nickel hydroxide, the half-value width of the diffraction peak corresponding to the crystal 001 plane of the nickel hydroxide is greater than or equal to 2 (2θ°), or there is no diffraction peak.

In the battery positive electrode active material of the present invention described above, the structure is more preferably formed so that the half-value width of the diffraction peak corresponding to the crystal 001 plane of the nickel hydroxide is greater than or equal to 4 (2θ°), or there is no diffraction peak.

In the battery positive electrode active material of the present invention described above, the structure is preferably formed so that the battery positive electrode active material contains at least one compound selected from nickel hydroxide, nickel oxyhydroxide, and derivatives of these which cause a redox reaction during battery operation and also contains a metal oxide or a derivative thereof which causes no redox reaction during battery operation.

In the structure described above, the metal oxide or the derivative thereof which causes no redox reaction during battery operation preferably includes a zirconic acid compound.

In the battery positive electrode active material of the present invention described above, the structure is preferably formed so that the battery positive electrode active material contains at least one compound selected from nickel hydroxide, nickel oxyhydroxide, and derivatives of these which cause a redox reaction during battery operation and also contains an inorganic-organic hybrid compound in which an organic polymer having a hydroxyl group is chemically bonded to a metal oxide or a derivative thereof which cause no redox reaction during battery operation, and the inorganic-organic hybrid compound has a property of absorbing an alkaline liquid electrolyte.

In this structure, the metal oxide or the derivative thereof which causes no redox reaction during battery operation also preferably includes a zirconic acid compound. In addition, the organic polymer having a hydroxyl group preferably includes a polyvinyl alcohol.

A battery of the present invention comprises a positive electrode; a negative electrode; and a liquid electrolyte, and the positive electrode contains the battery positive electrode active material of the present invention. The battery of the present invention may be applied to one of a nickel hydride battery, a nickel zinc battery, and a nickel iron battery. The battery of the present invention may also be applied to an in-car battery.

A method for producing a battery positive electrode active material of the present invention is a method for producing the battery positive electrode active material of the present invention described above and produces a battery positive electrode active material through a step of neutralizing a nickel salt by an alkali in a state of coexisting with an organic polymer having a hydroxyl group to form an inorganic-organic hybrid compound in which nickel hydroxide or a derivative thereof is chemically bonded to the organic polymer having a hydroxyl group.

In addition, the step in which the inorganic-organic hybrid compound is formed so that the nickel hydroxide or the derivative thereof is chemically bonded to the organic polymer having a hydroxyl group may be performed by removing a solvent from a solution in which the nickel salt and the organic polymer having a hydroxyl group coexist with each other to form a solid material and by bringing this solid material into contact with the alkali to neutralize the nickel salt in the solid material.

In addition, in this production method, after the inorganic-organic hybrid compound is formed, an organic component in the inorganic-organic hybrid compound may be removed by oxidation. In addition, the removal of the organic component in the inorganic-organic hybrid compound by oxidation may be performed by heating in the air.

In addition, in this production method, the organic polymer preferably includes a polyvinyl alcohol.

Another method for producing a battery positive electrode active material of the present invention produces a battery positive electrode active material through a step of neutralizing a nickel salt and a salt of a metal component of a metal oxide or a derivative thereof which causes no redox reaction during battery operation by an alkali in a state of coexisting with an organic polymer having a hydroxyl group to form an inorganic-organic hybrid compound in which nickel hydroxide or a derivative thereof and the metal oxide or the derivative thereof which causes no redox reaction are chemically bonded to the organic polymer having a hydroxyl group.

In addition, the step in which the inorganic-organic hybrid compound is formed so that the nickel hydroxide or the derivative thereof and the metal oxide or the derivative thereof which causes no redox reaction are chemically bonded to the organic polymer having a hydroxyl group may be performed by removing a solvent from a solution in which the organic polymer having a hydroxyl group coexists with the nickel salt and the salt of the metal component of the metal oxide or the derivative thereof which causes no redox reaction to form a solid material and by bringing this solid material into contact with the alkali to neutralize the nickel salt and the salt of the metal component of the metal oxide or the derivative thereof which causes no redox reaction, each of which is contained in the solid material.

In this production method, after the inorganic-organic hybrid compound is formed, an organic component in the inorganic-organic hybrid compound may be removed by oxidation. In addition, the removal of the organic component of the inorganic-organic hybrid compound may be performed by heating in the air.

In addition, in this production method, the metal oxide or the derivative thereof which causes no redox reaction preferably includes a zirconic oxide, and the organic polymer preferably includes a polyvinyl alcohol.

### Advantageous Effects of Invention

According to the structure of the battery positive electrode active material of the present invention, since nickel hydroxide, nickel oxyhydroxide, or at least one derivative thereof which causes a redox reaction is fine particles with sufficiently low crystallinity, amorphous fine particles, or fine particles, such as nanoparticles, the memory effect is suppressed, and the charge/discharge potential curve is flat. That is, in a diffraction intensity-angle diagram obtained by a powder X-ray diffraction method using CuKα radiation in the state in which the active material contains nickel hydroxide, the half-value width of the diffraction peak corresponding to the crystal 001 plane of the nickel hydroxide is greater than or equal to 2 (2θ°), or there is no diffraction peak, and since the nickel hydroxide, the nickel oxyhydroxide, or the derivative thereof is actually fine particles with extremely low crystallinity, amorphous fine particles, or fine particles, such as nanoparticles, the suppression of the memory effect and the improvement in flatness of the charge/discharge potential curve can be realized.

In the battery positive electrode active material of the present invention, when the structure is formed so that the metal oxide or the derivative thereof which causes no redox reaction during battery operation coexists with nickel hydroxide, nickel oxyhydroxide, or at least one derivative thereof, fine particles with low crystallinity, amorphous fine particles, or fine particles, such as nanoparticles, are likely to be formed, and in addition, the state of the fine particles can be stably maintained.

In the battery positive electrode active material of the present invention, furthermore, when the structure is formed so that the inorganic-organic hybrid compound in which the metal oxide or the derivative thereof which causes no redox reaction during battery operation is bonded to the organic polymer having a hydroxyl group coexists with nickel hydroxide, nickel oxyhydroxide, or at least one derivative thereof, as is the case described above, fine particles with low crystallinity, amorphous fine particles, or fine particles, such as nanoparticles, can also be likely to be formed, and in addition, the state of the fine particles can be stably maintained.

According to the structure of the battery of the present invention, since the positive electrode contains the battery positive electrode active material of the present invention, the memory effect is suppressed, and the flatness of the charge/discharge potential curve is preferable. Hence, the battery can be easily controlled, and the original battery performance can be sufficiently obtained.

According to the method for producing a battery positive electrode active material of the present invention, through the step of neutralizing a nickel salt by an alkali in a state of coexisting with an organic polymer having a hydroxyl group to form an inorganic-organic hybrid compound in which nickel hydroxide or a derivative thereof is chemically bonded to the organic polymer having a hydroxyl group, fine particles with extremely low crystallinity, amorphous fine particles, or fine particles, such as nanoparticles, of the nickel hydroxide or the derivative thereof can be easily produced.

According to another method for producing a battery positive electrode active material of the present invention, through the step of neutralizing a nickel salt and a salt of a metal component of a metal oxide or a derivative thereof which causes no redox reaction by an alkali in a state of coexisting with an organic polymer having a hydroxyl group to form an inorganic-organic hybrid compound in which nickel hydroxide or a derivative thereof and the metal oxide or the derivative thereof which causes no redox reaction are chemically bonded to the organic polymer having a hydroxyl group, fine particles with low crystallinity, amorphous fine particles, or fine particles, such as nanoparticles, of the nickel hydroxide or the derivative can be easily produced, and in addition, since an inorganic oxide which causes no redox reaction during battery operation or the inorganic-organic hybrid compound coexists, the battery positive electrode active material can be easily produced so as to stably maintain a low crystallinity or a fine particle property.

### BRIEF DESCRIPTION OF DRAWINGS

FIG. 1 is a system diagram schematically showing a representative embodiment of a process for producing a battery positive electrode active material according to the present invention.

FIG. 2A is a diffraction intensity-angle diagram of a conventional spherical high-density nickel hydroxide for batteries obtained by a powder X-ray diffraction method. FIG. 2B is a diffraction intensity-angle diagram of a battery positive electrode active material containing a nickel hydroxide of the present invention obtained by a powder X-ray diffraction method.

FIG. 3 shows charge/discharge potential curves of electrodes using (a) the conventional spherical high-density nickel hydroxide for batteries and (b) the battery positive electrode active material of the present invention.

FIG. 4A shows charge/discharge potential curves obtained before and after partial charge/discharge is performed 20 times between states of charge (SOC) of 30% to 70% of an electrode using the conventional spherical high-density nickel hydroxide for batteries. FIG. 4B shows charge/discharge potential curves obtained before and after partial charge/discharge is performed 20 times between states of charge (SOC) of 30% to 70% of an electrode using the battery positive electrode active material of the present invention.

### DESCRIPTION OF EMBODIMENTS

Hereinafter, embodiments of the present invention will be described.

A battery positive electrode active material of the present invention is a battery positive electrode active material containing at least one compound selected from nickel hydroxide, nickel oxyhydroxide, and derivatives of these which cause a redox reaction during battery operation, and in a diffraction intensity-angle diagram obtained by a powder X-ray diffraction method using CuKα radiation in a state in which the active material contains nickel hydroxide, basically, the half-value width of the diffraction peak corresponding to the crystal 001 plane of the nickel hydroxide is greater than or equal to 2 (2θ°), or there is no diffraction peak.

In more preferable, the structure is formed so that the half-value width of the diffraction peak corresponding to the crystal 001 plane of the nickel hydroxide is greater than or equal to 4 (2θ°), or there is no diffraction peak.

In addition, in the battery positive electrode active material of the present invention, the battery positive electrode active material preferably has the structure in which at least one compound selected from nickel hydroxide, nickel oxyhydroxide, and derivatives of these which cause a redox reaction during battery operation is not only contained, but also a metal oxide or a derivative thereof which causes no redox reaction during battery operation is contained.

In addition, in the battery positive electrode active material of the present invention, the battery positive electrode active material preferably has the structure in which at least one compound selected from nickel hydroxide, nickel oxyhydroxide, and derivatives of these which cause a redox reaction during battery operation is not only contained, but also an inorganic-organic hybrid compound in which a metal oxide or a derivative thereof which causes no redox reaction during battery operation is chemically bonded to an organic polymer having a hydroxyl group is contained, and furthermore, this inorganic-organic hybrid compound has a property of absorbing an alkaline liquid electrolyte.

In a method for producing of a battery positive electrode active material of the present invention, a battery positive electrode active material is produced through a step of neutralizing a nickel salt by an alkali in a state of coexisting with an organic polymer having a hydroxyl group to form an inorganic-organic hybrid compound in which nickel hydroxide or a derivative thereof is chemically bonded to the organic polymer having a hydroxyl group.

In another method for producing a battery positive electrode active material of the present invention, a battery positive electrode active material is produced through a step of neutralizing a nickel salt and a salt of a metal component of a metal oxide or a derivative thereof which causes no redox reaction during battery operation by an alkali in a state of coexisting with an organic polymer having a hydroxyl group to form an inorganic-organic hybrid compound in which nickel hydroxide or a derivative thereof and the metal oxide or the derivative thereof which causes no redox reaction during battery operation are chemically bonded to the organic polymer having a hydroxyl group.

In the present invention, the battery positive electrode active material contains at least one compound selected from nickel hydroxide, nickel oxyhydroxide, and derivatives thereof which causes a redox reaction during battery operation. Those nickel hydroxide, nickel oxyhydroxide, and derivatives thereof, that is, those nickel compounds, each may contain any nickel atom of not less than divalent, and since those nickel compounds each cause a redox reaction during battery operation, in an electrode operation potential range, the average valence of the nickel atom is changed. Since an electrode to which those active materials are applied is a positive electrode, the reactions represented by the above formulas (3) and (4) occur during charge/discharge. However, those reaction formulas are shown by simplifying material species to be generated as much as possible; hence, in practice, the valence of nickel, the number of hydrates thereof, and the like are variously changed. In particular, since those nickel compounds are each a layered compound, and water molecules, potassium hydroxide, sodium hydroxide, lithium hydroxide, and the like are intercalated between the layers from a liquid electrolyte, a complicated composition is formed. Furthermore, as described above, since different types of metals, such as cobalt and zinc, are generally solid-solved in a battery nickel hydroxide, also in the nickel compound of the present invention, as long as nickel is a primary metal component, any other metal components may be used for replacement or solid solution.

In the present invention, the nickel compound contained in the active material is preferably fine particles with low crystallinity, amorphous fine particles, or fine particles, such as nanoparticles. When the nickel compound is used as the positive electrode, as shown in the formula (4), in a discharged state, the nickel compound can be present in the form of nickel hydroxide. In addition, since nickel hydroxide is the most stable state in the air from a thermodynamic point of view, when the active material is formed, the active material is mainly produced in the form of nickel hydroxide. That is, in any one of the steps, the active material of the present invention can be placed in a state of containing nickel hydroxide. The abovementioned nickel hydroxide has a wide meaning and indicates the whole hydroxides of nickel having a valence of approximately 2. In addition, for example, in the nickel hydroxide, atoms other than nickel, oxygen, and hydrogen may be solid-solved, water molecules, potassium hydroxide, sodium hydroxide, lithium hydroxide, and the like may be intercalated between the layers, and the valence of nickel may be slightly shifted from 2. When the nickel compound in the active material is fine particles with low crystallinity, amorphous fine particles, or fine particles, such as nanoparticles, even if the nickel compound is in the form of nickel hydroxide, of course, fine particles with low crystallinity, amorphous fine particles, or fine particles, such as nanoparticles, are obtained. Hence, in the present invention, even when the nickel compound is in the form of nickel hydroxide, fine particles with sufficiently low crystallinity, amorphous fine particles, or fine particles, such as nanoparticles, are required, and in the case of the fine particles as described above, in a diffraction intensity-angle diagram obtained by a powder X-ray diffraction method using CuKα radiation, the half-value width of the diffraction peak corresponding to the crystal 001 plane of the nickel hydroxide is greater than or equal to 2 (2θ°). However, in order to more clearly realize the effect of fine particles with low crystallinity, amorphous fine particles, or fine particles, such as nanoparticles, the half-value width is preferably greater than or equal to 4 (2θ°), or there is preferably no diffraction peak.

The diffraction intensity-angle diagram is generally obtained as the result of the powder X-ray diffraction and indicates the relationship between the diffraction angle 20 and the counts of X-rays. When the material has a crystallinity, because of ordered lamination of crystal planes, a diffraction phenomenon of X-rays occurs, and at a specific diffraction angle corresponding to the spacing between the crystal planes, the counts of X-rays is significantly increased, so that in the diffraction intensity-angle diagram, a sharp peak can be obtained at the diffraction angle position. When the regularity of the crystal plane lamination is destroyed, or when the number of crystal planes to be laminated is small since the size of particles is small, the peak height is decreased, and the width thereof is increased, so that a broad peak is observed; hence, the half-value width (the peak width represented by the angle unit 2θ° at a position at which the height thereof is a half of that of the top of the diffraction peak) is increased. In addition, in the case of perfectly amorphous fine particles or fine particles, such as nanoparticles, in which the size of the material is too small to form a crystal, no diffraction peak is observed at all at a diffraction angle at which the peak is to be generated if the material is originally a crystal. That is, the half-value width becomes infinite. Hence, the half-value width can be regarded as the index representing low crystallinity of fine particles or the degree of amorphous fine particles, or fine particles, such as nanoparticles, and as this value is increased, the crystallinity is decreased, the degree of amorphousness is increased, and the size of fine particles is further decreased. In the diffraction intensity-angle diagram of the active material, the result in that the half-value width of the diffraction peak corresponding to the crystal 001 plane of the nickel hydroxide contained therein is greater than or equal to 2 (2θ°) indicates that the layered crystal is not so much grown; the result in that the half-value width is greater than or equal to 4 (2θ°) indicates that the layered crystal is hardly formed; and the result in that there is no diffraction peak indicates that the layered crystal is not grown at all. In the present invention, the half-value width of the diffraction peak corresponding to the crystal 001 plane of the nickel hydroxide is greater than or equal to 2 (2θ°) and is preferably greater than or equal to 4 (2θ°), or there is preferably no diffraction peak.

In the present invention, nickel hydroxide, nickel oxyhydroxide, or at least one derivative thereof which causes a redox reaction preferably coexists with a metal oxide or a derivative thereof which causes no redox reaction during battery operation. When the nickel compound which causes a redox reaction coexists in the form of fine particles, such as nanoparticles, with another metal oxide or a derivative thereof, agglomeration/growth or crystallization of the fine particles is inhibited, the state of fine particles with low crystallinity, amorphous fine particles, or fine particles, such as nanoparticles, is likely to be formed, and in addition, the fine particles can be stably maintained. Since the active material of the present invention is used mainly for a battery using an alkaline liquid electrolyte, the metal oxide or the derivative thereof, which coexists with the nickel compound, is also required to have a high alkaline resistance. In addition, since the metal oxide or the derivative thereof is required not to cause a redox reaction within the electrode operation potential and is also required to have a high alkaline resistance, a zirconic acid compound is preferably used as the metal oxide or the derivative thereof.

The zirconic acid compound is a compound formed of ZrO₂ as a basic unit and H₂O molecules provided therearound and can be represented by a general formula ZrO₂.xH₂O; however, the zirconic acid compound of the present invention indicates zirconic acid, a derivative thereof, or the whole compounds each primarily formed of zirconic acid. Hence, as long as the characteristics of zirconic acid are not degraded, the zirconic acid may be partially replaced with at least one different element, may be shifted from the chemical stoichiometric composition thereof, and may be allowed to contain at least one additive. For example, a salt or a hydroxide of the zirconic acid is also formed using ZrO₂ as the basic unit, and derivatives basically formed from the salt and the hydroxide or compounds primarily formed therefrom are also included in the zirconic acid compound of the present invention.

In the present invention, as the material allowed to coexist with the nickel compound which causes a redox reaction, there may be used an inorganic-organic hybrid compound in which a metal oxide or a derivative thereof which causes no redox reaction during battery operation is chemically bonded to an organic polymer.

In order to inhibit the agglomeration/growth or the crystallization of fine particles of the nickel compound, the coexisting material advantageously has a property of forming an amorphous continuous body so as to be in contact with the entire fine particles of the nickel compound, and basically, an organic polymer is more advantageous than an inorganic material, such as a metal oxide. However, many organic polymers have a low affinity to an inorganic material and strongly tend to be separated therefrom, and as a result, the organic polymers have a small effect on the nickel compound. Although some organic polymers have a high affinity to an inorganic material, since many of them have a polar group and a high hydrophilic property, those organic polymers are dissolved in a liquid electrolyte. If an organic polymer having a high affinity to an inorganic material is chemically bonded to the nickel compound, the elution thereof into the liquid electrolyte can be suppressed. However, since a large material change of the nickel compound which causes a redox reaction occurs during battery operation, even if the chemical bond is formed once, this bond may be probably dissociated. In addition, although active species, such as radicals, are likely to be generated at the battery electrode, and the positive electrode forms an environment having a very strong oxidizing power, among organic polymers, a hydrocarbon-based polymer is particularly weak against oxidation and radicals and cannot withstand the environment in the electrode, and as a result, for example, the problem of decomposition may frequently arise. Although a fluorine-containing polymer has a higher chemical stability, the material cost thereof is not only high, but also toxic gases, such as hydrogen fluoride, are generated in combustion, so that cost for waste treatment and recycle treatment is unfavorably increased. In addition, since many organic polymers have a hydrophobic property, in this case, the liquid electrolyte is not absorbed therein, and as a result, the ion conduction between the nickel compound and the liquid electrolyte is blocked.

When the inorganic-organic hybrid compound is used as the material which is allowed to coexist with the nickel compound, the problem of the organic polymer as described above can be solved. The inorganic-organic hybrid compound to be allowed to coexist with the nickel compound is a compound in which the metal oxide or the derivative thereof which causes no redox reaction during battery operation and the organic polymer having a hydroxyl group are chemically bonded to each other. Since the inorganic-organic hybrid compound is used, an amorphous continuous body can be formed as is the case of an organic polymer and can be in contact with the entire fine particles of the nickel compound. In addition, since also having characteristics of an inorganic material, the inorganic-organic hybrid compound has a high affinity to the nickel compound and has a stable bond thereto, and hence, the effect of inhibiting the particle growth, crystal growth, and the like is high. In addition, as the characteristics of an inorganic material, resistance against oxidation and radicals is high. Furthermore, although having a hydrophilic property, since the organic polymer is bonded to the inorganic material, the organic polymer is not dissolved in the liquid electrolyte. In addition, since capable of absorbing the liquid electrolyte, even when the inorganic-organic hybrid compound encloses nickel or the nickel compound in the form of the continuous body, the ion transfer is not inhibited.

If the metal oxide or the derivative thereof of the inorganic-organic hybrid compound causes a redox reaction during battery operation, while the battery is charged and discharged, the inorganic-organic hybrid compound is also largely changed. Hence, for example, the inorganic-organic hybrid compound itself is decomposed, and the stable state is difficult to maintain, so that the effect of suppressing the fine particle growth and the crystallization growth for the nickel compound may be disadvantageously influenced.

Hence, in the present invention, the inorganic-organic hybrid compound in which the metal oxide or the derivative thereof which causes no redox reaction during battery operation and the organic polymer are chemically bonded to each other is used. In addition, since the active material of the present invention is mainly used for a battery using an alkaline liquid electrolyte, the active material is required to have a high alkaline resistance so as to withstand a strong alkali, and from this point of view, the metal oxide or the derivative thereof of the inorganic-organic hybrid compound is also required to have a high alkaline resistance. In order not to cause a redox reaction within the electrode operation potential and to have a high alkaline resistance, as the metal oxide or the derivative thereof, a zirconic acid compound is preferable.

As the organic polymer having a hydroxyl group of the inorganic-organic hybrid compound which is allowed to coexist with the nickel compound, any organic polymer may be basically used. The most representative organic polymer to be used in the present invention is a polyvinyl alcohol, and a polyvinyl alcohol is to be bonded to an inorganic material with its hydroxyl group interposed therebetween. When an organic polymer component of the inorganic-organic hybrid compound is a polyvinyl alcohol, this polyvinyl alcohol is not required to be a perfect polymer, and a polymer which can basically function as a polyvinyl alcohol may be used. For example, a polymer having a hydroxyl group partially replaced with another group and a polymer having a portion copolymerized with another polymer can also function as a polyvinyl alcohol. In addition, when a polyvinyl alcohol is present in the reaction process of the present invention, since the effect similar to that described above can be obtained, for example, a polyvinyl acetate to be used as a raw material of a polyvinyl alcohol may also be used as a starting raw material.

In the inorganic-organic hybrid compound, the metal oxide or the derivative thereof which causes no redox reaction during battery operation and the organic polymer having a hydroxyl group are chemically bonded to each other. That is, those two types of materials are tangled with each other at a molecular level or a nano level and are also strongly bonded to each other by dehydration condensation through the hydroxyl group of the organic polymer. The hybrid compound is a compound and is discriminated from a mixture formed by physical mixing between the metal oxide or the derivative thereof and the organic polymer. That is, unlike the mixture, in the hybrid compound, the chemical characteristics of each constituent component are not always maintained after the hybridization is performed. For example, in the case of the present invention, although a polyvinyl alcohol, which is one constituent component of the hybrid compound, is water soluble (hot-water soluble) by itself, after the hybrid compound is formed with the zirconic acid compound, basically, a polyvinyl alcohol is not dissolved in hot water. As described above, after the hybridization is performed, the chemical characteristics are changed, and hence, it can be said that a hybrid compound different from the mixture obtained by physical mixing of those materials.

In the inorganic-organic hybrid compound, when the amount of the inorganic material with respect to that of the organic polymer is too small, sufficient water resistance, alkaline resistance, and oxidation resistance cannot be obtained. On the other hand, when the amount of the inorganic material is too large, the flexibility is degraded, and a function of enclosing the nickel compound fine particles is degraded. Hence, the weight ratio of the weight of the metal oxide or the derivative thereof which causes no redox reaction to the weight of the organic polymer in the hybrid compound is preferably controlled to 0.01 to 1.

Next, a method for producing a battery positive electrode active material of the present invention will be described.

In one production method of the present invention, a battery positive electrode active material is obtained through a step of neutralizing a nickel salt by an alkali in a state of coexisting with an organic polymer having a hydroxyl group to form an inorganic-organic hybrid compound in which nickel hydroxide or a derivative thereof is chemically bonded to the organic polymer having a hydroxyl group.

In addition, in another production method of the present invention, a battery positive electrode active material is obtained through a step of neutralizing a nickel salt and a salt of a metal component of a metal oxide or a derivative thereof which causes no redox reaction by an alkali in a state of coexisting with an organic polymer having a hydroxyl group to form an inorganic-organic hybrid compound in which nickel hydroxide or a derivative thereof and the metal oxide or the derivative thereof which causes no redox reaction are chemically bonded to the organic polymer having a hydroxyl group.

In each production method described above, as an organic polymer component having a hydroxyl group which forms the inorganic-organic hybrid compound with nickel hydroxide or the derivative thereof, basically, any materials may be used. Although a polyvinyl alcohol, various cellulose derivatives, and the like may be used, the most representative organic polymer to be used in the present invention is a polyvinyl alcohol, and a polyvinyl alcohol is bonded to nickel hydroxide or the derivative thereof with its hydroxyl group interposed therebetween. When the organic polymer component of the inorganic-organic hybrid compound is a polyvinyl alcohol, this polyvinyl alcohol is not required to be a perfect polymer, and a polymer which can basically function as a polyvinyl alcohol may be used. For example, a polymer having a hydroxyl group partially replaced with another group and a polymer having a portion copolymerized with another polymer can also function as a polyvinyl alcohol. In addition, when a polyvinyl alcohol is present in the reaction process of the present invention, since the effect similar to that described above can be obtained, for example, a polyvinyl acetate to be used as a raw material of a polyvinyl alcohol may also be used as a starting raw material.

When the nickel salt is in a stable state, in general, the nickel thereof is divalent, and when the nickel salt is neutralized by an alkali, nickel hydroxide is generated except in a particular oxidative or reductive environment. On the other hand, in the production method of the present invention, since the organic polymer having a hydroxyl group coexists, when being generated, nickel hydroxide is also bonded to the organic polymer with its hydroxyl group interposed therebetween. That is, a nascent small nickel hydroxide generated by the neutralization is unstable and is likely to be bonded to any component for stabilization. In this step, when the nickel salt is only present, newborn nickel hydroxide molecules are bonded to each other, are agglomerated, and are grown; however, when the polymer having a hydroxyl group is present in the vicinity thereof, the newborn nickel hydroxide molecules are also bonded to the polymer described above. Since nickel hydroxide is bonded to the polymer, the nickel hydroxide is suppressed from being grown and remains in the form of fine particles, such as nanoparticles. In the present invention, as described above, fine particles, such as nanoparticles, of nickel hydroxide can be formed. The nickel hydroxide bonded to the organic polymer at a molecular level or a nano level as described above is also suppressed from being crystallized.

In the inorganic-organic hybrid compound described above, the nickel hydroxide and the organic polymer having a hydroxyl group are chemically bonded to each other. That is, these two types of compounds are not only tangled with each other at a molecular level or a nano level but also strongly bonded to each other by dehydration condensation with the hydroxyl group of the organic polymer interposed therebetween. The hybrid compound is a compound and is discriminated from a mixture formed by physical mixing between nickel hydroxide and the organic polymer. That is, unlike the mixture, in the hybrid compound, the chemical characteristics of each constituent component are not always maintained after the hybridization is performed. For example, although a polyvinyl alcohol, which is one representative example of the constituent component of the hybrid compound formed by the production method of the present invention, is water soluble (hot-water soluble) by itself, after the hybrid compound is formed with nickel hydroxide or the derivative thereof, basically, a polyvinyl alcohol is not dissolved in hot water. As described above, after the hybridization is performed, the chemical characteristics are changed, and hence, it can be said that a hybrid compound different from the mixture obtained by physical mixing of those materials can be obtained.

When the inorganic-organic hybrid compound formed of the nickel hydroxide and the organic polymer having a hydroxyl group as described above itself is used as a battery active material, the nickel hydroxide is changed to a different material by oxidation or reduction, and in this step, the bond to the organic polymer is liable to be dissociated. When this bond is dissociated, since being changed to a simple polymer, the polymer having a hydroxyl group is eluted in a liquid electrolyte or is decomposed due to degradation in oxidation resistance, and as a result, problems may arise in the battery in some cases. In particular, in a sealed type secondary battery, when oxidation of this organic polymer is advanced in the battery, the problem in that the amounts of charge reserve and discharge reserve of the negative electrode are largely shifted from the ideal state may occur. In addition, since the amount of a liquid electrolyte is limited to small in a sealed type battery, oxidation products from the organic polymer are liable to adversely influence the liquid electrolyte. In order to avoid those problems, the polymer having a hydroxyl group can be intentionally removed by oxidation performed in advance before the battery active material is supplied in the battery. For example, when heating is performed in the air, the polymer can be removed by combustion.

During the neutralization of the nickel salt, when the salt of the metal component of the metal oxide or the derivative thereof which causes no redox reaction during battery operation is allowed to coexist with the nickel salt so that the salt is also neutralized by an alkali, as is the case of the nickel hydroxide, neutralized products of the salt are also bonded to the organic polymer having a hydroxyl group, and as a result, the inorganic-organic hybrid compound is formed. Since this metal oxide or the derivative thereof causes no redox reaction during battery operation unlike the nickel hydroxide, the inorganic-organic hybrid compound can be stably maintained during battery operation, so that as described above, the inorganic-organic hybrid compound has a function to suppress the growth of the nickel compound. In this case, although dissolution, oxidation decomposition, and the like of the organic polymer are not likely to occur in the battery, in order to completely prevent the above problems, as is the case described above, before the battery active material is supplied in the battery, the organic polymer may be removed by oxidation in advance. For example, by heating in the air, the organic polymer can be removed by combustion. In the case described above, since the metal oxide or the derivative thereof which causes no redox reaction during battery operation remains without being oxidized, as a result, the function to suppress the growth of the nickel compound can be maintained.

As long as the nickel salt is dissolved in a solvent to be used, any type of nickel salt, such as nickel sulfate, nickel nitrate, nickel chloride, nickel acetate, or a hydrate thereof, may be used, and the moisture content thereof may be arbitrarily selected. Although the metal oxide or the derivative thereof which causes no redox reaction during battery operation is preferably a zirconic acid compound, as the salt thereof, any type of salt may be used as long as generating the zirconic acid compound by neutralization with an alkali and a stable inorganic-organic hybrid compound of the zirconic acid compound and the organic polymer having a hydroxyl group. A zirconium salt or an oxyzirconium salt may be used, and for example, zirconium oxychloride, zirconium acetate, zirconium nitrite, or a hydrate thereof may be used.

According to one embodiment of the method for producing a battery positive electrode active material of the present invention, a process of forming an inorganic-organic hybrid compound in which nickel hydroxide or a derivative thereof is chemically bonded to an organic polymer having a hydroxyl group is performed by removing a solvent from a solution in which a nickel salt coexists with the organic polymer having a hydroxyl group to form a solid material and then by bringing this solid material into contact with an alkali to neutralize the nickel salt in the solid material.

In addition, according to another embodiment of the method for producing a battery positive electrode active material of the present invention, a process of forming an inorganic-organic hybrid compound in which nickel hydroxide or a derivative thereof and a metal oxide or a derivative thereof which causes no redox reaction are chemically bonded to an organic polymer having a hydroxyl group is performed by removing a solvent from a solution in which a nickel salt and a salt of a metal component of the metal oxide or the derivative thereof which causes no redox reaction coexist with the organic polymer having a hydroxyl group to form a solid material and then by bringing this solid material into contact with an alkali to neutralize the nickel salt and the salt of the metal component of the metal oxide or the derivative thereof which causes no redox reaction in the solid material.

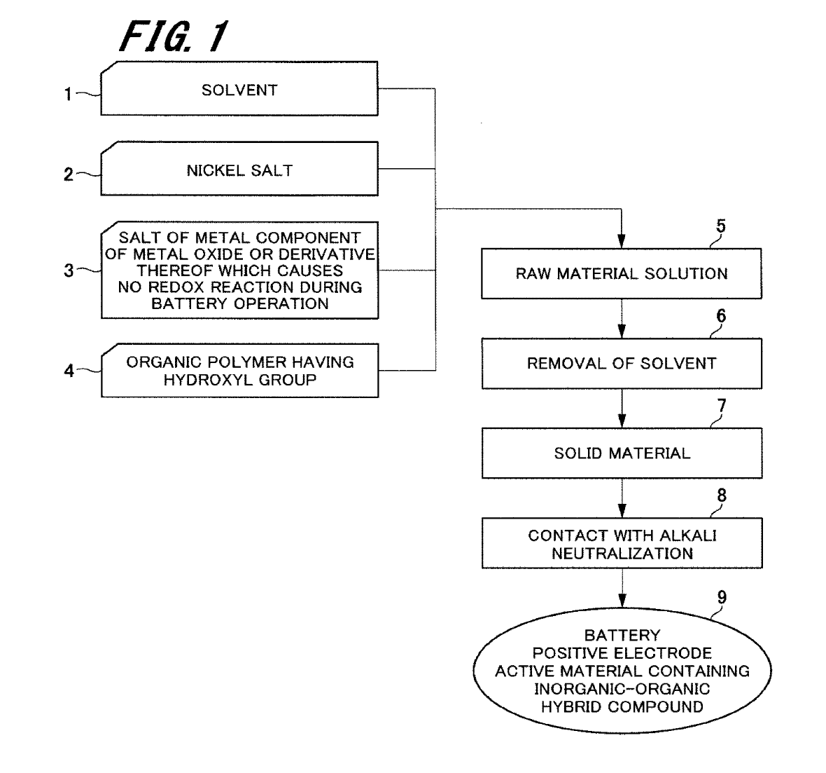

Next, a system diagram schematically showing one embodiment of the production method described above is shown in FIG. 1.

As shown in FIG. 1, first, as raw materials, a solvent, a nickel salt, a salt of a metal oxide or a derivative thereof which causes no redox reaction during battery operation (if needed), and an organic polymer having a hydroxyl group are prepared in a step 1, a step 2, a step 3, and a step 4, respectively.

Subsequently, in a step 5, those raw materials are mixed together, so that a raw material solution in which the nickel salt, the salt of the metal oxide or the derivative thereof which causes no redox reaction during battery operation, and the organic polymer having a hydroxyl group coexist with each other is obtained. In this step, as the solvent, any solvent may be used as long as the nickel salt, the salt of a metal component of the metal oxide or the derivative thereof which causes no redox reaction, and the organic polymer having a hydroxyl group each can be dissolved therein. As described above, a representative example of the salt of the metal component of the metal oxide or the derivative thereof is a zirconium salt or an oxyzirconium salt, and a representative example of the organic polymer is a polyvinyl alcohol, in this case, the most preferable solvent is water.

Next, in a step 6, the solvent is removed from the raw material solution in which the nickel salt, the salt of the metal oxide or the derivative thereof which causes no redox reaction during battery operation, and the organic polymer having a hydroxyl group coexist with each other, so that a solid material is obtained in a step 7.

Subsequently, in a step 8, the solid material is brought into contact with an alkali to neutralize each of the nickel salt and the salt of the metal component of the metal oxide or the derivative thereof which causes no redox reaction, and in a step 9, a battery positive electrode active material is obtained which contains an inorganic-organic hybrid compound in which nickel hydroxide or a derivative thereof and the metal oxide or the derivative thereof which causes no redox reaction are chemically bonded to the organic polymer having a hydroxyl group. In this case, since nickel hydroxide particles to be generated are inhibited from being grown and also suppressed from being crystallized by the bond thereof to the organic polymer or by the generation of the hybrid compound formed from the metal oxide or the derivative thereof which causes no redox reaction and the organic polymer, each of which is adjacent to the nickel hydroxide particles, in a diffraction intensity-angle diagram obtained by a powder X-ray diffraction method, the half-value width of the diffraction peak corresponding to the crystal 001 plane is greater than or equal to 2 (2θ°) or greater than or equal to 4 (2θ°), or there is no diffraction peak.

In the step 7, the solid material containing the nickel salt, the salt of the metal oxide or the derivative thereof which causes no redox reaction during battery operation, and the organic polymer having a hydroxyl group may have any form, and for example, a film form, a fiber form, and a powder form may be available. In view of easy handling, among those forms mentioned above, the film form is preferable.

In the case of the film form, this form may be formed in such a way that the raw material solution is cast on a flat plane, and the solvent is then removed by heating.

In the case of the fiber form, for example, this form may be formed in such a way that the raw material solution is ejected from a nozzle having a small hole, and at the same time, the solvent is removed by heating. An electrospinning method in which while an electric field is applied, the raw material solution is sprayed out in the form of fibers may also be used.

In the case of the powder form, this form may be formed by a spray dry method in which the raw material solution is sprayed, and at the same time, the solvent is removed by heating. In the case of forming the powder form or a particle form, a method in which without removing the solvent, liquid droplets of the raw material solution are immersed in an alkali may also be used.

In the neutralization step performed by an alkali in the step 8, in order to efficiently perform the neutralization in a short time, since the specific surface area of the solid material is preferably large, the thickness of the film form is preferably 1 mm or less, the diameter of the fiber form is preferably 1 mm or less, and the diameter of the powder form is also preferably 1 mm or less.

In the step 8, as the alkali to be brought into contact with the solid material after the removal of the solvent, any alkali may be used as long as the neutralization of those compounds can be performed, and for example, potassium hydroxide, sodium hydroxide, or lithium hydroxide may be used. Those materials may be used alone, or at least two types thereof may be used in combination. When an alkaline solution is used, basically, although the concentration of the alkali may be arbitrarily determined, for example, in order to shorten the time of the neutralization step, to suppress the change in solution concentration in a neutralization reaction, or to perform the neutralization reaction before the components are each eluted out of the solid material, the concentration of the alkaline solution is preferably high. As a method for bringing the solid material into contact with an alkali, for example, there may be mentioned a method in which the solid material is immersed in the alkaline solution, a method in which the alkaline solution is applied or sprayed on the mixed compound, and a method in which the solid material is exposed to an alkaline vapor.

As described above, cobalt and/or zinc is solid-solved in nickel hydroxide used conventionally in a battery, and as is the case described above, in the active material of the present invention, when a cobalt salt and/or a zinc salt is dissolved in a raw material mixture solution of the step 5 shown in FIG. 1, cobalt and/or zinc can be solid-solved.

The organic polymer in the inorganic-organic hybrid compound contained in the active material thus formed can be removed in advance by oxidation when the problems of dissolution of the organic polymer in the liquid electrolyte and the oxidation decomposition of the organic polymer are required to be avoided in the case in which the active material is assembled in a sealed type battery. In the case described above, a method for performing heating in the air is simplest, and for example, oxidation can be performed by heating at 200° C. to 300° C. In this step, when heating is performed at a temperature of 250° C. or more for a long time, since nickel hydroxide is dehydrated into a nickel oxide and may be deactivated for charge/discharge in some cases, the heating is preferably performed within one hour. A residue obtained after the oxidation of the organic polymer is ideally removed by water washing or alkaline washing.

Hereinafter, particular examples of the battery positive electrode active material according to the present invention will be described. In addition, the present invention is not limited to the contents described in the following examples.

### Example 1

The battery positive electrode active material according to the present invention was actually produced, and the characteristics thereof were investigated.

A solution formed by dissolving a predetermined amount of nickel nitrate hexahydrate and a predetermined amount of zirconium oxychloride octahydrate in 40 ml of water was mixed with 14 g of an aqueous solution of a polyvinyl alcohol (degree of polymerization: 3,100 to 3,900, degree of saponification: 86% to 90%) at a concentration of 10 percent by weight, so that a raw material mixture solution was formed.

Next, this raw material mixture solution was cast on a polyester film placed on a smooth stage of a coating device (K control coater 202, manufactured by R K Print Coat Instruments Ltd.) equipped with a blade which could adjust the gap from the stage using a micrometer. In this step, heating was performed so that the stage was set to a temperature of 55° C. Immediately after a predetermined amount of a raw material solution was cast on the stage, the blade adjusted to have a gap of 0.5 mm was swept on the raw material solution at a constant rate so that the solution had a constant thickness. Furthermore, the solution was left while the heating was performed, so that moisture was evaporated. By the operation described above, the nickel salt, the oxyzirconium salt, and the polyvinyl alcohol were mixed together, so that a film-shaped solid material was formed.

Next, the film-shaped solid material thus formed was peeled away from the stage, was then immersed in a sodium hydroxide solution at a concentration of 7 percent by weight, and was finally left for one night. By the operation described above, the nickel salt and the oxyzirconium salt were neutralized by the alkali and were bonded to the polyvinyl alcohol, so that a hybrid compound was formed.

After the film-shaped material was recovered from the sodium hydroxide solution, was then washed with water, and was finally dried, this material was coarsely pulverized by a mixer, and heating was then performed in an oven at 130° C. for 30 minutes. Subsequently, by the use of a ball mill, this material was more finely pulverized, so that a battery positive electrode active material was obtained.

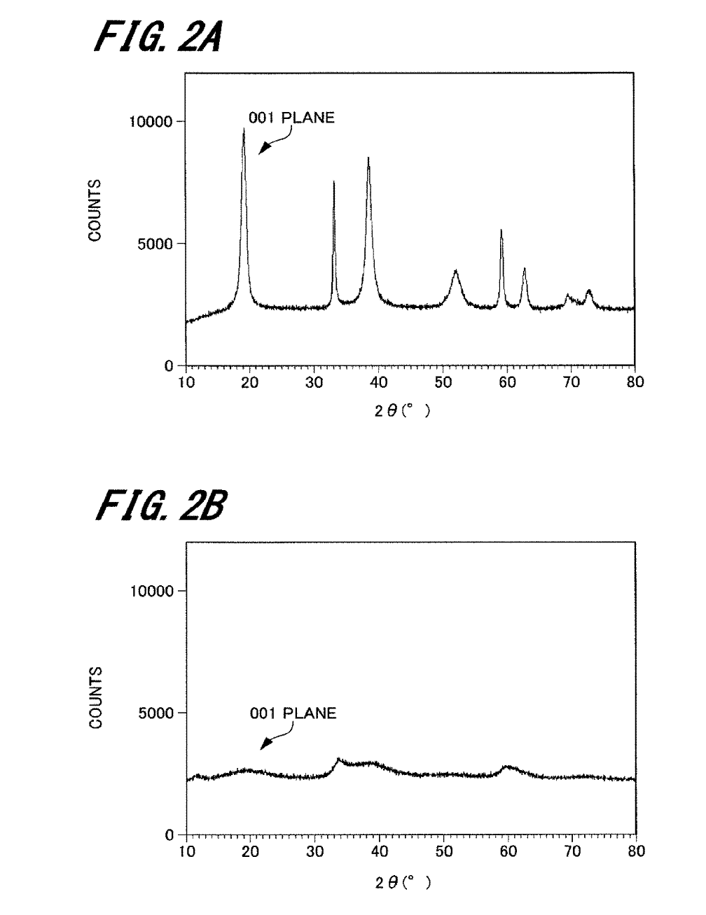

A powder X-ray diffraction (X'Part Pro, using CuKα radiation, manufactured by PANalytical) was performed on the active material thus obtained. The diffraction intensity-angle diagram thus obtained is shown in FIG. 2B. In addition, the diffraction intensity-angle diagram of a conventional battery high-density spherical nickel hydroxide is shown in FIG. 2A which was obtained under the same conditions as those of the above. In both measurements, the measurement conditions of the powder X-ray diffraction were set to 45 kV, 40 mA, and a scanning rate of 0.002°/sec.

As shown in FIG. 2A, in the conventional battery high-density spherical nickel hydroxide, a sharp diffraction peak derived from the crystal structure can be clearly observed. On the other hand, as shown in FIG. 2B, in the battery positive electrode active material of this example, a sharp peak could not be observed. The half-value width of the diffraction peak corresponding to the crystal 001 plane of the conventional spherical high-density nickel hydroxide was 0.8 (2θ°) and was smaller than or equal to 2 (2θ°). On the other hand, the diffraction peak corresponding to the crystal 001 plane of the battery positive electrode active material of this example was very broad, and the height thereof was low, when the half-value width thereof was obtained in accordance with the definition, it was 6.1 (2θ°) and was greater than or equal to 4 (2θ°).

### Example 2

Next, an electrode was formed using the battery positive electrode active material of the present invention, and the electrode characteristics thereof were evaluated.

After the active material powder formed in Example 1, a nickel powder, and a cobalt oxide powder were mixed with each other so as to have contents of 75, 20, and 5 percent by weight, respectively, 0.35 g of this mixture was mixed with 0.03 g of a dispersion of a polytetrafluoroethylene (60 percent by weight, manufactured by Aldrich), was then filled in spongy nickel (Cermet, manufactured by Sumitomo Electric Industries, Ltd.) which was cut into a 2 cm square, and was finally pressed at a pressure of 7 MPa for 1 minute, so that the electrode was formed. After leads were fitted to the electrode, the electrode was immersed in an aqueous potassium hydroxide solution at a concentration of 30 percent by weight filled in a beaker.

After the electrode was fully charged and was then left for one night, the electrode was charged and discharged under conditions at a room temperature of 20° C. using a nickel plate as a counter electrode with a hydrogen occluding alloy electrode (represented by MH (1 atom)) as a reference electrode which was regarded to be approximately equilibrium to adsorbed hydrogen at 1 atom. First, when all nickel compounds in the active material were regarded as nickel hydroxide, charged/discharge was performed once at a current of 10 mA per one gram of the nickel hydroxide (10 mA/g), and next, charge/discharge was performed six times by increasing the current to 50 mA/g, so that the active material was activated. Subsequently, the current was set to 1 C (current by which the discharge was completed for one hour), and partial charge/discharge was performed 20 times between states of charge (SOC) of 30% to 70%.

In addition, the charge/discharge potential curve at a current of 50 mA/g and the charge/discharge potential curves of a first partial charge/discharge and a twentieth partial charge/discharge between states of charge (SOC) of 30% to 70% were each measured.

In addition, as a comparative reference, a conventional battery nickel hydroxide was used instead of the active material powder formed in Example 1, and an electrode was formed by a method similar to that of Example 2.

The charge/discharge potential curve of the electrode formed using the conventional battery nickel hydroxide was also measured as was the case described above.

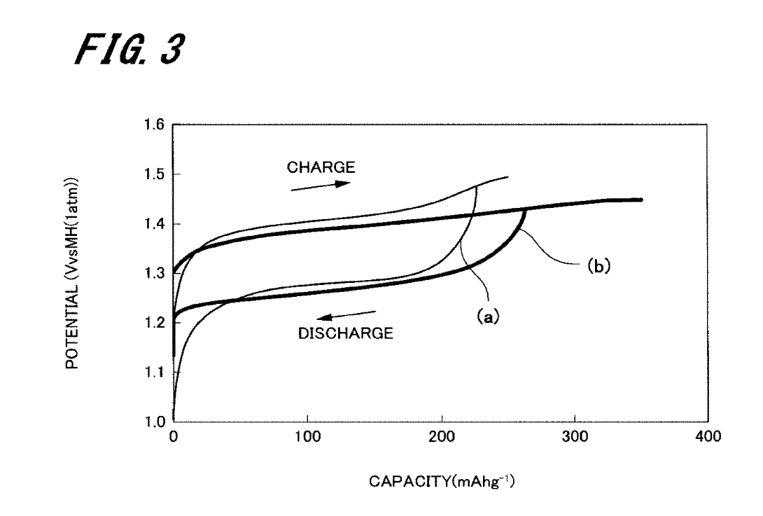

The charge/discharge potential curve of the electrode using the battery positive electrode active material formed in this example and the charge/discharge potential curve of the electrode using the conventional battery nickel hydroxide formed in a manner similar to that described above are shown in FIG. 3 for comparison. In FIG. 3, (a) represents the charge/discharge potential curve of the electrode using the conventional battery nickel hydroxide, and (b) represents the charge/discharge potential curve of the electrode using the battery positive electrode active material formed in this example.

From FIG. 3, it is found that compared to the conventional battery nickel hydroxide, the flatness of the potential of the active material of this example is superior, and in particular, in the conventional nickel hydroxide, although a rapid decrease in potential is observed at a discharge end period, in the active material of this example, the linearity of the potential is maintained even in the region described above.

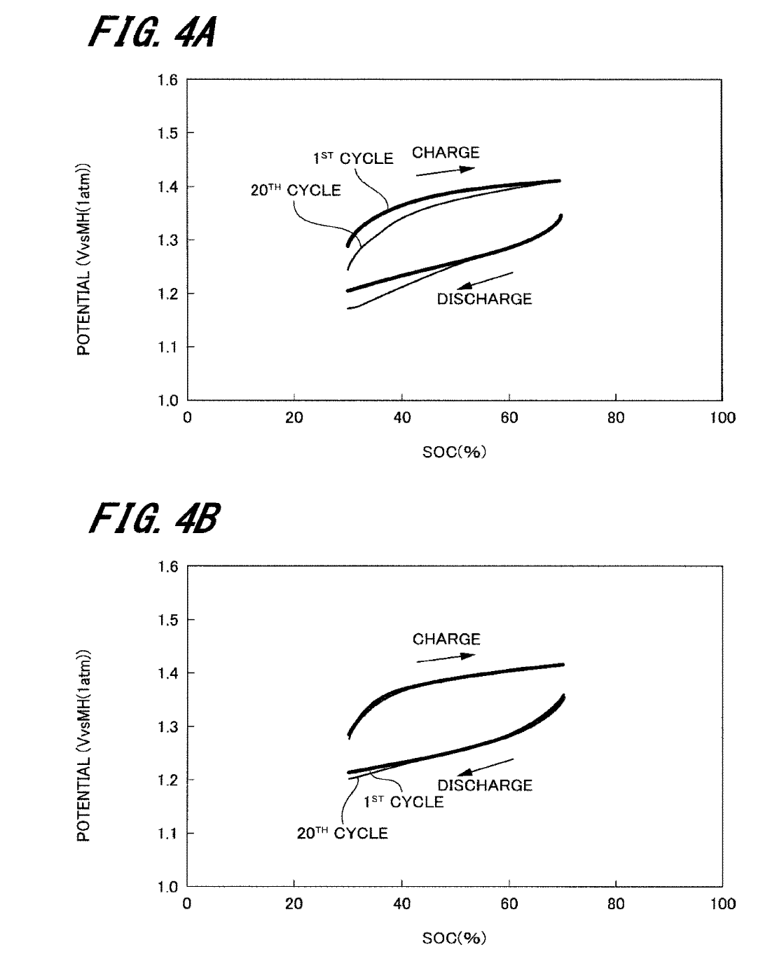

The results obtained by performing partial charge/discharge 20 times between states of charge (SOC) of 30% to 70% are shown in FIGS. 4A and 4B. FIG. 4A shows the charge/discharge potential curves before and after the charge/discharge was performed 20 times on the electrode using the conventional battery nickel hydroxide, and FIG. 4B shows the charge/discharge potential curves before and after the charge/discharge was performed 20 times on the electrode using the battery positive electrode active material formed in this example. Since the memory effect appears when the conventional nickel hydroxide is used, as shown in FIG. 4A, when partial charge/discharge is repeated, the potential is largely fell at a portion of the discharge end period; however, when the active material of the present invention is used, as shown in FIG. 4B, although partial charge/discharge is repeated, the change in potential is small. Accordingly, by the battery positive electrode active material of the present invention, such as the battery positive electrode active material formed in this example, it can be said that the memory effect is significantly suppressed. Those effects can be obtained since, in the active material of the present invention, the nickel compound is formed of fine particles, such as nanoparticles, and is not crystallized as shown in FIG. 2. The result in that even after the charge/discharge is repeated, the change in potential is small indicates that in the active material of the present invention, the fine particles, such as nanoparticles, of the nickel compound is stably maintained even when the charge/discharge is repeated.

### Example 3

Except that the raw material mixture solution was prepared without adding zirconium oxychloride octahydrate, in a manner similar to that of Example 1, a battery positive electrode active material was formed from an inorganic-organic hybrid compound in which nickel hydroxide or a derivative thereof was bonded to a polyvinyl alcohol.

A powder X-ray diffraction was performed in a manner similar to that of Example 1 on the battery positive electrode active material formed in this example, and the half-value width of the diffraction peak corresponding to the crystal 001 plane of the nickel hydroxide was 2.8 (2θ°) and was greater than or equal to 2 (2θ°).

In addition, by using a powder of the active material formed in this example instead of the active material powder formed in Example 1, an electrode was formed by a method similar to that of Example 2.

### Example 4

An active material formed in a manner similar to that of Example 1 was heated at 200° C. for 1 hour to remove a polyvinyl alcohol by oxidation, so that a battery positive electrode active material was formed.

A powder X-ray diffraction was performed in a manner similar to that of Example 1 on the battery positive electrode active material formed in this example, and a result almost similar to that of Example 1 was obtained.

In addition, by using a powder of the active material formed in this example instead of the active material powder formed in Example 1, an electrode was formed by a method similar to that of Example 2.

### Example 5

An active material formed in a manner similar to that of Example 3 was heated at 200° C. for 1 hour to remove a polyvinyl alcohol by oxidation, so that a battery positive electrode active material was formed.

A powder X-ray diffraction was performed in a manner similar to that of Example 1 on the battery positive electrode active material formed in this example, and a result almost similar to that of Example 3 was obtained.

In addition, by using a powder of the active material formed in this example instead of the active material powder formed in Example 1, an electrode was formed by a method similar to that of Example 2.

Measurement of the charge/discharge potential curve of the electrode formed in each of Examples 3 to 5 was performed.

The electrode formed in Example 4 showed a charge/discharge curve almost similar to that shown in FIG. 3(b) except that the flatness was slightly inferior.

Although the electrode formed in Example 3 and the electrode formed in Example 5 each showed a charge/discharge curve almost similar to that shown in FIG. 3(b) and a flatter curve than that of the conventional battery nickel hydroxide, the flatness of the curve of each electrode was slightly inferior to that of the electrode containing a zirconic acid compound.

In addition, when partial charge/discharge was repeated on each electrode, as similar to that shown in FIG. 4B, although the memory effect was small as compared to that of the conventional battery nickel hydroxide (FIG. 4A), the electrode containing no zirconic acid compound and the electrode containing no polyvinyl alcohol showed a slightly larger memory effect than that of the electrode containing a zirconic acid compound and the electrode containing a polyvinyl alcohol, respectively. It is believed that depending on the presence or absence of a material coexisting with the nickel compound or depending on material species coexisting therewith, the effect of stably maintaining the nickel compound fine particles is slightly changed, and that an electrode containing a zirconic acid compound or a polyvinyl alcohol or a hybrid compound in which those materials are bonded to each other has a higher effect of stably maintaining the nickel compound fine particles.

In addition, since the charge/discharge potential curves shown in FIGS. 3 and 4B are the results obtained by evaluating the electrode itself which uses the active material of the present invention, the above charge/discharge potential curves are generated only from the active material of the present invention, and when a battery is formed therefrom, the characteristics are obtained independent of the negative electrode. Hence, in all the batteries using the positive electrode active material of the present invention, such as a nickel hydride battery, a nickel iron battery, and a nickel zinc battery, an effect similar to that described above can also be obtained.

In addition, in this example, although the inorganic-organic hybrid compound using a polyvinyl alcohol was described above by way of example, a polyvinyl alcohol is formed only from a hydrocarbon chain and a hydroxyl group bonded thereto and has the simplest structure among organic polymers having a hydroxyl group. Hence, the fact that the effect of the present invention is obtained by using a polyvinyl alcohol as described in this example indicates that an effect similar to that described above can also be obtained from all the organic polymers having a hydroxyl group.

### Reference Example

As a reference example for the present invention, among the battery positive electrode active materials of the present invention, a material containing no nickel compound, that is, a material formed only from an inorganic-organic hybrid compound in which a metal oxide or a derivative thereof which causes no redox reaction during battery operation and an organic polymer having a hydroxyl group were chemically bonded to each other, was formed, and the characteristics of this material were investigated.

First, a raw material mixture liquid was formed by dissolving 0.7 g of zirconium oxychloride octahydrate in 14 g of an aqueous solution of a polyvinyl alcohol (degree of polymerization: 3,100 to 3,900, degree of saponification: 86% to 90%) at a concentration of 10 percent by weight. Hereinafter, by the same method as that of Example 1, a film-shaped material was formed through an alkaline immersion treatment. When this film-shaped material was immersed in an aqueous potassium hydroxide solution at a concentration of 30 percent by weight which was similar to a liquid electrolyte composition of a nickel hydrogen battery, the film-shaped material was swelled, and hence, it was confirmed that this material absorbed a large amount of an aqueous potassium hydroxide solution.

In addition, after two chambers (inside volume: 20 cc) separated by this film-shaped material were formed and were each filled with an aqueous potassium hydroxide solution at a concentration of 30 percent by weight, when a voltage of 1.8 V was applied between nickel mesh electrodes disposed at two sides of the film-shaped material, a large current per unit battery area of 15 mA/cm² was allowed to flow, and water electrolysis occurred. This result indicates that the inorganic-organic hybrid compound formed from a zirconic acid compound which causes no redox reaction during battery operation and a polyvinyl alcohol having a hydroxyl group absorbs an alkaline liquid electrolyte and has a high ion conductivity.

In the above Example 2, the reason the charge/discharge reaction is not inhibited although the active material contains the inorganic-organic hybrid compound formed from a zirconic acid compound and a polyvinyl alcohol is believed that since the inorganic-organic hybrid compound absorbs an alkaline liquid electrolyte, the ion conductivity is not inhibited. Since the zirconic acid compound causes no redox reaction within the electrode operation potential of a battery, such as a nickel hydride battery, using an aqueous liquid electrolyte, the inorganic-organic hybrid compound is not basically changed even during battery operation, and as a result, fine particles of the nickel compound can be stably maintained.

### INDUSTRIAL APPLICABILITY

According to the battery positive electrode active material of the present invention, since nickel hydroxide, nickel oxyhydroxide, or a derivative thereof which causes a redox reaction during battery operation is in the form of fine particles with low crystallinity, amorphous fine particles, or fine particles, such as nanoparticles, characteristics in which the charge/discharge potential curve is flat, the memory effect is not likely to occur, and the like are obtained. Accordingly, in a secondary battery in which nickel hydroxide, nickel oxyhydroxide, or a derivative thereof is used as the positive electrode active material, and particularly, in a nickel hydride battery, when the battery positive electrode active material of the present invention is used, merits in that the control can be easily performed, the original battery performance can be sufficiently used, and the like can be obtained. Hence, a secondary battery which is likely to be applied to an in-car battery, in particular, for a hybrid car or the like can be provided.

1. A battery positive electrode active material containing: at least one compound selected from nickel hydroxide, nickel oxyhydroxide, and derivatives of these which cause a redox reaction during battery operation,
wherein in a diffraction intensity-angle diagram obtained by a powder X-ray diffraction method using CuKα radiation in a state in which the active material contains nickel hydroxide, the half-value width of the diffraction peak corresponding to the crystal 001 plane of the nickel hydroxide is greater than or equal to 2 (2θ°), or there is no diffraction peak.

2. The battery positive electrode active material according to claim 1, wherein the half-value width of the diffraction peak corresponding to the crystal 001 plane of the nickel hydroxide is greater than or equal to 4 (2θ°), or there is no diffraction peak.

3. The battery positive electrode active material according to claim 1, wherein the battery positive electrode active material contains at least one compound selected from nickel hydroxide, nickel oxyhydroxide, and derivatives of these which cause a redox reaction during battery operation and also contains a metal oxide or a derivative thereof which causes no redox reaction during battery operation.

4. The battery positive electrode active material according to claim 3, wherein the metal oxide or the derivative thereof which causes no redox reaction during battery operation includes a zirconic acid compound.

5. The battery positive electrode active material according to claim 1, wherein the battery positive electrode active material contains at least one compound selected from nickel hydroxide, nickel oxyhydroxide, and derivatives of these which cause a redox reaction during battery operation and also contains an inorganic-organic hybrid compound in which an organic polymer having a hydroxyl group is chemically bonded to a metal oxide or a derivative thereof which cause no redox reaction during battery operation, and
the inorganic-organic hybrid compound has a property of absorbing an alkaline liquid electrolyte.

6. The battery positive electrode active material according to claim 5, wherein the metal oxide or the derivative thereof which causes no redox reaction during battery operation includes a zirconic acid compound.

7. The battery positive electrode active material according to claim 5, wherein the organic polymer having a hydroxyl group includes a polyvinyl alcohol.

8. A battery comprising: a positive electrode; a negative electrode; and a liquid electrolyte,
wherein the positive electrode contains the battery positive electrode active material according to claim 1.

9. The battery according to claim 8, wherein the battery is one of a nickel hydride battery, a nickel zinc battery, and a nickel iron battery.

10. The battery according to claim 8, wherein the battery is a nickel hydride battery.

11. The battery according to claim 8, wherein the battery is an in-car battery.

12. A method for producing the battery positive electrode active material according to claim 1, the method comprising:
a step of neutralizing a nickel salt by an alkali in a state of coexisting with an organic polymer having a hydroxyl group to form an inorganic-organic hybrid compound in which nickel hydroxide or a derivative thereof is chemically bonded to the organic polymer having a hydroxyl group.

13. The method for producing the battery positive electrode active material according to claim 12, wherein the step in which the inorganic-organic hybrid compound is formed so that the nickel hydroxide or the derivative thereof is chemically bonded to the organic polymer having a hydroxyl group is performed by removing a solvent from a solution in which the nickel salt and the organic polymer having a hydroxyl group coexist with each other to form a solid material and by bringing the solid material into contact with the alkali to neutralize the nickel salt in the solid material.

14. The method for producing the battery positive electrode active material according to claim 12, wherein after the inorganic-organic hybrid compound is formed, an organic component in the inorganic-organic hybrid compound is removed by oxidation.

15. A method for producing the battery positive electrode active material according to claim 3 or 5, the method comprising:
a step of neutralizing a nickel salt and a salt of a metal component of the metal oxide or the derivative thereof which causes no redox reaction by an alkali in a state of coexisting with an organic polymer having a hydroxyl group to form an inorganic-organic hybrid compound in which nickel hydroxide or a derivative thereof and the metal oxide or the derivative thereof which causes no redox reaction are chemically bonded to the organic polymer having a hydroxyl group.

16. The method for producing the battery positive electrode active material according to claim 15,
wherein the step in which the inorganic-organic hybrid compound is formed so that the nickel hydroxide or the derivative thereof and the metal oxide or the derivative thereof which causes no redox reaction are chemically bonded to the organic polymer having a hydroxyl group is performed by removing a solvent from a solution in which the organic polymer having a hydroxyl group coexists with the nickel salt and the salt of the metal component of the metal oxide or the derivative thereof which causes no redox reaction to form a solid material and by bringing the solid material into contact with the alkali to neutralize the nickel salt and the salt of the metal component of the metal oxide or the derivative thereof which causes no redox reaction, each of which is contained in the solid material.

17. The method for producing the battery positive electrode active material according to claim 15, wherein after the inorganic-organic hybrid compound is formed, the battery positive electrode active material according to claim 3 is produced by removing an organic component in the inorganic-organic hybrid compound by oxidation.

18. The method for producing the battery positive electrode active material according to claim 15, wherein the metal oxide or the derivative thereof which causes no redox reaction includes a zirconic acid compound.

19. The method for producing the battery positive electrode active material according to claim 12 or 15, wherein the organic polymer having a hydroxyl group includes a polyvinyl alcohol.

20. The method for producing the battery positive electrode active material according to claim 14 or 17, wherein the removal of the organic component in the inorganic-organic hybrid compound by oxidation is performed by heating in the air.
